(19) United States
(12) Patent Application Publication
(10) Pub. No.: US 2025/0290781 A1
(43) Pub. Date: Sep. 18, 2025

(54) FLOW SENSOR AND PHOTOACOUSTIC DETECTOR

(71) Applicant: UST Umweltsensortechnik GmbH, Geratal OT Geschwenda (DE)

(72) Inventors: Olaf KIESEWETTER, Geratal OT Geschwenda (DE); Nils KIESEWETTER, Geratal OT Geschwenda (DE); Alexander KRAUSSER, Geratal (DE); Matthias MAY, Schmalkalden (DE)

(73) Assignee: UST Umweltsensortechnik GmbH, Geratal OT Geschwenda (DE)

(21) Appl. No.: 19/078,580

(22) Filed: Mar. 13, 2025

(30) Foreign Application Priority Data
Mar. 15, 2024 (DE) 10 2024 107 379.9

(51) Int. Cl. G01F 1/692; G01D 21/02; G01N 21/3504

(52) U.S. Cl. CPC G01F 1/692; G01D 21/02; G01N 21/3504

(57) ABSTRACT

A flow sensor may have a substrate with a groove. A resistance meander may have a plurality of platinum thin-film tracks arranged on the substrate, which tracks have webs which cross the groove. A lid may be arranged on the substrate covering the resistance meander, which lid has a groove aligned with the groove in the substrate, so that the grooves form a flow channel for the medium. One or more apertures may be arranged in the substrate and/or in the lid for the lateral flow of a medium into the groove. One aperture in the lid and one aperture in the substrate may be arranged such that a medium entering the groove through one of the apertures sweeps over several of the webs or all webs before it reaches the other aperture.

### FIELD

The invention relates to a flow sensor and a photoacoustic detector.

### BACKGROUND

Flow sensors based on the anemometer principle are widespread and easy to use in many areas. The principle is based on the effect that a heated body or a heated surface can release energy into the environment. The surrounding media can be gaseous, liquid or solid. The energy dissipation depends on the surface and the physical properties of the medium as well as the flow velocity of the passing medium and the type of flow (turbulent or laminar). With zero flow, the energy output is only determined by convection, the physical properties of the medium and the surface of the heated body.

Flow sensors that work according to the anemometer principle are described in numerous patent applications and patents. DE 42 24 518 C2 describes an arrangement in silicon in which a meander-shaped resistor structure is partially mounted on a dielectric support structure that has a flow channel passing through the silicon body. DE 10 2013 209 951 A1 describes arrangements in which pairs of thermocouples are used for temperature detection. DE 10 2009 029 169 A1 describes an arrangement in which vortex bodies are attached. DE 10 210 042 307A1 describes an arrangement in which heaters and a temperature sensor are mounted separately.

Furthermore, flow sensors are known that are capable of detecting gas flows in a detector chamber in a miniaturized photoacoustic detector, which are generated by the expansion of the preferably gaseous medium due to energy absorption. However, known solutions with pressure sensors are usually too insensitive. The use of miniature microphones is limited by the high lower cut-off frequency of approx. 50 Hz to 100 Hz. The flow sensors used in large classic photoacoustic detectors are too large and cannot be used in the envisaged detector chambers.

The object of the invention is to provide a new type of flow sensor and a new type of photoacoustic detector.

According to the invention, the object is achieved by a flow sensor and by a photoacoustic detector according to the appended set of claims.

Advantageous embodiments of the invention are the subject of the subclaims.

### SUMMARY

A flow sensor is proposed, which has a substrate with a groove, wherein a resistance meander comprising several platinum thin-film tracks is arranged on the substrate, which have webs that cross the groove. The groove can be closed at its ends. In particular, the groove in the substrate can initially be made continuous and can later be closed when the flow sensor is mounted in order to change the direction of flow.

According to the invention, a lid is arranged on the substrate covering the resistance meander, which has a groove aligned with the groove in the substrate, so that the grooves form a flow channel for the medium. The groove can be closed at its ends. In particular, the groove in the lid can initially be made continuous and later be closed when the flow sensor is installed.

According to the invention, one or more apertures are arranged in the substrate and/or in the lid for lateral flow of a medium into the groove. According to the invention, an aperture in the lid and an aperture in the substrate are arranged in such a way that a medium entering the groove through one of the apertures sweeps over several of the webs or all of the webs before reaching the other aperture and exiting there.

In one embodiment, a temperature sensor is arranged on the substrate, which can also be used as a heater.

In one embodiment, the webs are about 10 μm wide and/or about 1 μm thick and/or five to ten webs are provided. In technological terms, web widths of 5 μm with a thickness of around 0.8 μm can be realized. The number of webs can be up to 100 or more.

In one embodiment, the substrate is designed as a ceramic substrate.

In one embodiment, the substrate has dimensions of 2 mm by 2 mm by 1 mm; 1 mm by 1 mm by 0.5 mm is also useful.

In one embodiment, the webs cross the groove at right angles or approximately at right angles. The openings can, for example, open into the groove at right angles or approximately at right angles. The webs can be connected in parallel or in series or consist of a combination of both.

According to one aspect of the present invention, a photoacoustic detector is proposed comprising a closed, optically tight and gas-tight housing (the tightness is to be given over the service life of the detector) which encloses a detector chamber and a buffer chamber which is separated from the detector chamber by an optically tight partition wall having a bore, wherein a transparent entrance window is arranged in the housing between an environment and the detector chamber, through which the detector chamber and a medium located therein can be irradiated, the buffer chamber being designed as a Helmholtz resonator, a flow sensor being arranged in or on the partition wall as described above and positioned in such a way that a change in pressure of the medium in the detector chamber as a result of irradiation leads to an equalizing flow via the flow sensor into the buffer chamber. The irradiation is, for example, pulsed with a frequency of approx. 5 Hz to 10 Hz.

In one embodiment, the detector chamber and/or the buffer chamber have a closed volume of less than 1 cm³.

The present invention proposes a flow sensor capable of detecting, in a miniaturized photoacoustic (PA) detector, gas flows between a detector chamber and a buffer chamber generated by the expansion of the medium due to energy absorption.

The flow sensor can be designed in such a way that it is capable of detecting flows with cut-off frequencies of 0 to 50 Hz, in particular 5 Hz to 10 Hz, with dimensions of 2 mm by 2 mm by 1 mm, for example. The measuring sensitivity can be such that the pressure changes caused by energy input into a closed volume of less than 1 cm³ lead to a measurable flow at the sensor and this can be converted into a corresponding output voltage that correlates with the energy consumption of the PA sensor. The measuring current can be pulsed for this purpose.

### DESCRIPTION OF THE FIGURES

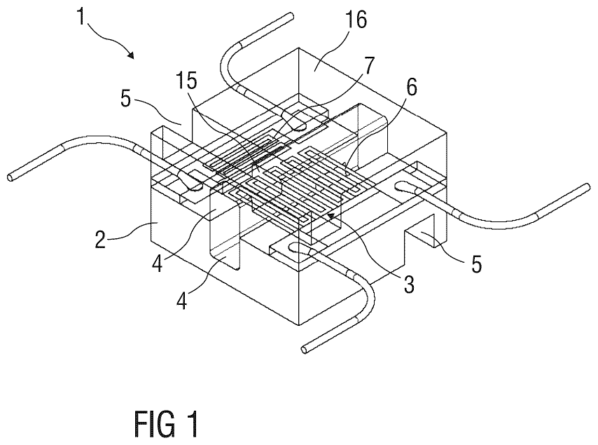

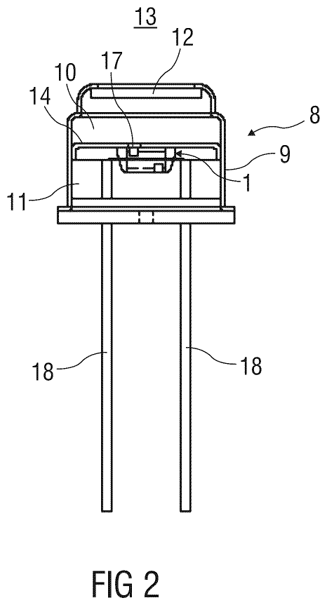

Examples of embodiments of the invention are explained in more detail below with reference to drawings, wherein FIG. 1 is a schematic view of a flow sensor, and FIG. 2 is a schematic view of a photoacoustic detector.

### DETAILED DESCRIPTION

Corresponding parts are marked with the same reference signs in all figures.

FIG. 1 is a schematic view of a flow sensor 1

For example, the flow sensor 1 may have a substrate 2, for example a ceramic substrate 2. A resistance meander 3 consisting of several freely suspended platinum thin-film tracks is arranged on the substrate 2 (produced in a batch process, for example), which have webs 6 that run at an angle of 90°, for example, over a groove 4 in the substrate 2 and are therefore cooled by a medium that flows through the groove 4, also known as a flow channel. In order to generate a turbulent flow in the medium, one or more apertures 5 are arranged in the substrate 2, for example at right angles to the groove 4, via which the flow can be directed towards the groove 4, so that vortices can arise at a tear-off edge 15, which are amplified at the webs 6 and lead to additional vortices and turbulence, thus enabling improved energy transfer from the medium to the webs 6. The tear-off edge 15 is the edge at which the flow is deflected by 90 degrees. This can also be created by a constriction in the groove 4. A lid 16 can be arranged on the substrate 2, which has a groove 4 aligned with the groove 4, so that the grooves 4 form a flow channel for the medium. An aperture 5 can also be arranged in the lid 16, for example at right angles to the groove 4, via which the flow can be directed towards the groove 4, so that vortices can be created at a tear-off edge 15, which are amplified at the webs 6 and lead to additional vortices and turbulence, thus enabling improved energy transfer from the medium to the webs 6. The aperture 5 in the lid 16 and the aperture 5 in the substrate 2 can be arranged in such a way that a medium entering the groove 4 through one of the apertures 5 sweeps over several of the webs 6 or all webs 6 before it reaches the other aperture 5.

To suppress and/or compensate for temperature influences, a temperature sensor 7 is formed on the flow sensor 1, in particular the substrate 2, which can also be used as a heater so that the temperature of the flow sensor 1 can be kept constant. The temperature sensor 7 can be made of platinum and covered by a glass layer or glass passivation and thus protected.

For example, the webs 6 of the resistance meander 3 can be around 10 μm wide and around 1 μm thick. For example, five to ten or more webs 6 can be provided.

The groove 4 is shown open at its ends in FIG. 1. This may be due to the manufacturing process if the flow sensor 1 is manufactured in a batch process. The ends of the groove can be closed for the application of the flow sensor 1. Alternatively, the flow sensor 1 could be manufactured with the groove closed at the ends.

FIG. 2 is a schematic view of a photoacoustic detector 8, comprising a housing 9, in particular a gas-tight housing, which encloses a detector chamber 10 and a buffer chamber 11 separated from the detector chamber 10 by a partition wall 14 with a bore 17. Furthermore, an entrance window 12 is arranged in the housing 9 between an environment 13 and the detector chamber 10, through which the detector chamber 10 and a medium located therein can be irradiated. The entrance window 12 is permeable to infrared radiation, which can be absorbed by the irradiated medium. The buffer chamber 11 is designed as a Helmholtz resonator and is shielded from the irradiation by the partition wall 14. The flow sensor 1 from FIG. 1 is arranged in or on the partition wall 14. The medium can flow from the detector chamber 10 via the bore 17 into the aperture 5 in the substrate 2, from there further into the groove 4 in the substrate 2 and lid 16 and along the webs 6 to the aperture 5 in the substrate 2 and lid 16 and from there into the buffer chamber 11 or in the opposite direction.

The flow sensor 1 is able to detect flows of the medium, in particular a gas, in the detector chamber 10 in the (miniaturized) photoacoustic detector 8, which are generated by the expansion of the medium due to energy absorption (irradiation).

The flow sensor 1 can be designed in such a way that it is able to detect flows with cut-off frequencies of 0 to 50 Hz with dimensions of, for example, 2 mm by 2 mm by 1 mm. The measuring sensitivity can be such that the pressure changes caused by energy input into a closed volume of the detector chamber 10 and the buffer chamber 11 of, for example, less than 1 cm³ lead to a measurable flow at the flow sensor 1, which can be measured as a change in resistance of the flow sensor 1, which is converted into a voltage by a bridge circuit with the reference sensor, which correlates with the energy absorption of the photoacoustic detector 8.

The temperature sensor 7, which can also be used as a heater, can be used to keep the average temperature of the medium in the detector chamber 10 and/or the buffer chamber 11 constant.

The flow sensor 1 is positioned in the housing 9 so that the pressure change in the detector chamber 10 generated by the energy absorption of the medium can flow via the flow sensor 1 and the partition wall 14 with bore 17 into the non-irradiated buffer chamber 11. Electrical connections 18 of the flow sensor 1 for the resistance meander 3 and/or the temperature sensor 7 are led out of the housing 9 for this purpose.

### LIST OF REFERENCE SIGNS

1 flow sensor
2 substrate, ceramic substrate
3 resistance meander
4 groove
5 aperture
6 web
7 temperature sensor
8 photoacoustic detector
9 housing
10 detector chamber
11 buffer chamber
12 entrance window
13 environment
14 partition wall
15 tear-off edge
16 lid
17 bore
18 electrical connections

1. A flow sensor comprising a substrate with a groove, wherein a resistance meander comprising a plurality of platinum thin-film tracks is arranged on the substrate, which tracks have webs which cross the groove, wherein a lid is arranged on the substrate covering the resistance meander, which lid has a groove aligned with the groove in the substrate, so that the grooves form a flow channel for the medium, one or more apertures being arranged in the substrate and/or in the lid for the lateral flow of a medium into the groove, wherein one aperture in the lid and one aperture in the substrate are arranged such that a medium entering the groove through one of the apertures sweeps over several of the webs or all webs before it reaches the other aperture.

2. The flow sensor according to claim 1, wherein a temperature sensor, which can also be used as a heater, is arranged on the substrate.

3. The flow sensor according to claim 1, wherein the webs are 5 μm to 10 μm wide and/or 0.8 μm to 1 μm thick.

4. The flow sensor according to claim 1, wherein five to ten or up to 100 webs are provided.

5. The flow sensor according to claim 1, wherein the substrate is designed as a ceramic substrate.

6. The flow sensor according to claim 1, wherein the substrate has dimensions of 2 mm by 2 mm by 1 mm.

7. The flow sensor according to claim 1, wherein the webs cross the groove at right angles or approximately at right angles.

8. The flow sensor according to claim 1, wherein the apertures open into the groove at right angles or approximately at right angles.

9. A photoacoustic detector, comprising a gas-tight housing which encloses a detector chamber and a buffer chamber separated from the detector chamber by a partition wall with a bore, wherein a transparent entrance window is arranged in the housing between an environment and the detector chamber, through which window the detector chamber and a medium located therein can be irradiated, wherein the buffer chamber is designed as a Helmholtz resonator, wherein a flow sensor according to claim 1 is arranged in or on the partition wall with bore and positioned in such a way that a pressure change of the medium in the detector chamber as a result of irradiation leads to an equalizing flow via the flow sensor into the buffer chamber.

10. The photoacoustic detector according to claim 9, wherein the detector chamber and/or the buffer chamber have a closed volume of less than 1 cm³.

11. The flow sensor according to claim 1, wherein the substrate has dimensions of 1 mm by 1 mm by 0.5 mm.
